(19) United States
(12) Patent Application Publication
(10) Pub. No.: US 2010/0071921 A1
(43) Pub. Date: Mar. 25, 2010

(54) ENVIRONMENTALLY ADVANTAGEOUS ELECTRIC DRILL WITH EFFICIENCY PROMOTING CHARGE STATE INDICATOR

(75) Inventors: Serafino CANINO, Torrington, CT (US); Scott GELORMINO, Burlington, CT (US)

Correspondence Address: THOMPSON HINE L.L.P.;Intellectual Property Group, P.O. BOX 8801, DAYTON, OH, 45401-8801, US

(73) Assignee: ICC INNOVATIVE CONCEPTS CORPORATION, Canton, CT (US)

(21) Appl. No.: 12/236,502

(22) Filed: Sep. 24, 2008

(51) Int. Cl. B25B 23/00; B23Q 5/00

(52) U.S. Cl. 173/20; 173/217

(57) ABSTRACT

In accordance with the invention, a drill comprises a drill housing with a handle portion and a driver portion. A push button battery tester extends battery life. An electrical drill motor is located in the driver portion. The drill motor has an output shaft for coupling output rotary power. An electrical switch controls the operation of the drill motor. The electrical switch it is located on the handle portion of the drill housing. A chuck is coupled to the output shaft of the drill motor.

### CROSS REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The invention relates to electric drills which promote the ability of the user to efficiently use stored power.

### BACKGROUND OF THE INVENTION

Electrically powered drills remain one of the mainstays of every tool box, whether it be that of a homeowner or construction professional. Even going back to the 1950s, electrical drills were in very common use in the home, with companies like Sears Roebuck & Co. and others turning out high quality products at modest prices in what was then a very old technology.

Indeed, the most modem form of the electric drill, namely a pistol shaped device with a multi-fingered chuck that could be tightened using a conical gear key, followed closely the development of these chucks by the Jacobs Manufacturing Co. in or about 1902. Except for the introduction of a switch to reverse drive direction and the introduction of rechargeable batteries in recent years, the technology remains essentially static.

While they have been available on the market for many years, about 20 years ago, electric powered drills and other tools came into prominence. Because the structural aspects of these tools which performed directly the work for which they are intended differed from earlier tools only by the substitution of battery power, designs largely emulated conventional tools powered by house current.

In accordance with the present invention, however, recognition of the limitations of battery power are recognized with a charge state indicator. More particularly, in accordance with the invention charge state testing is performed using battery tester circuitry which draws power only when it is in use. This is in contrast to other battery-powered drills which utilize charge state indicators which continuously monitor battery power. The result is that if a drill is not used everyday or at least not charging continuously, prior art drills will prematurely lose charge. This means that when it is time to use them, if they have not been continuously charged, they will not work.

Moreover, if the electric drill is recharged, the charge followed by discharge followed by recharge operation has the effect of prematurely shortening the life of the battery. Besides being associated with significant economic costs, premature disposal of rechargeable batteries, which have a limited charge/recharge cycle life, does unnecessary environmental damage.

Alternatively, if the electric drill has been continually plugged into the house current, it has been continually drawing electricity, which consumes energy, causes pollution, and, albeit inefficiently, produces heat (increasing air conditioning load). Thus, the alternative of continuous charging is also disadvantageous.

While continuously operating charge state indicators in, for example, mobile phones poses little problems, as such devices are routinely recharged and used every day, in the context of an electric drill, the same, despite their common usage, is an unrecognized and serious problem.

### SUMMARY OF THE INVENTION

In accordance with the invention, it has been recognized that, in some respects, battery-powered electric drills differ fundamentally from electric drills which are plugged into alternating current outlets as are commonly found in houses, offices and other facilities. First of all, these battery-powered tools may only be operated for a limited amount of time. In addition, batteries, while they do provide efficiency of effort as compared to conventional alternating current powered tools, do involve considerable expense. In addition, proper disposal of the batteries carries added costs. In connection with this, it is also noted that rechargeable batteries do have a limited life in terms of the number of times which they may be recharged.

More particularly, reversible drills of the battery powered variety may, by mistake, be powered with a drill bit going in the wrong direction. This results in loss of power and depletion of battery life. Many times, this may occur for a prolonged period of time and is only discovered when the lack of progress, for example, in drilling a hole, becomes apparent. In addition, operation of a drill in reverse against the workpiece may cause a drill bit to overheat. If a screw or bolt is properly seated in a workpiece and it is desired to unscrew it, operation in the forward direction may cause it to strip threads cut in the workpiece.

It will be understood that the prevention of such rotation inadvertently in the wrong direction will be effective to preserve battery life and prevent damage to drill bits, finished work and the like.

In an effort to avoid this problem, drills with directional switches often have the switches labeled with, for example, alphanumeric silkscreen-type markings. Alternatively, markings may be molded into a part. However, markings may be difficult to read, and with time, may chip away. In addition, such markings are typically on or adjacent to the drill actuation switch and are thus not easily visible, because of their position, and may even be covered by the fingers of the individual using the battery-powered drill.

In accordance with the invention, it has been recognized that drills often lose their charge for reasons unrelated to the amount of work being done. For example, it has been recognized that in many circumstances, drills are operated to perform a task but are positioned improperly, requiring that the work be repeated. Worst than that, sometimes a new workpiece needs to be obtained and this involves waste of workpieces and the materials from which they are made with consequent loss of any labor which has been expanded to make the same and associated environmental damage.

In an effort to address these problems, prior art electrical drills may be provided with a light. Generally, this has involved the use of a light emitting diode which may extend from the body of the electrical drill. Alternatively, the prior art shows the use of a light emitting diode which is recessed inside the drill. Typically, the light emitting diode is aimed at the place where the drilling or other operation, such as tightening or unscrewing of a screw, is done.

In accordance with the invention, a drill comprises a drill housing with a handle portion and a driver portion. An electrical drill motor is located in the driver portion. The drill motor has an output shaft for coupling output rotary power. An electrical switch controls the operation of the drill motor. The electrical switch is located on the handle portion of the drill housing. A chuck is coupled to the output shaft of the drill motor.

A light is positioned to principally illuminate those areas of the workpiece which are likely to be visible to the user of the tool.

The inventive drill also comprises charge state measuring circuitry having a plurality of output terminals. Actuation of the output terminals or a combination of output terminals each corresponds to a particular state of charge. A red indicator light is coupled to one of the output terminals. One of the output terminals indicates a relatively poor state of charge. A green indicator light is coupled to an other one of the output terminals. The other one of the output terminals indicates a relatively good state of charge. A charge test switch actuates the charge state measuring circuitry. The charge state measuring circuitry further comprises an output terminal for driving a yellow light. The charge state measuring circuitry actuates the yellow light to indicate a condition which is neither good nor poor. It also actuates the green light and the yellow light simultaneously to indicate a battery charge condition that is better than that indicated by the yellow light but not as good as that indicated by the green light. The measuring circuitry also actuates the red light and the yellow light simultaneously to indicate a battery charge condition that is worse than that indicated by the yellow light but not as bad as that indicated by the red light. The indicator lights may be located on the left side of the handle portion of the drill housing.

In accordance with the invention, a green directional indicator and a red directional indicator are included to indicate movement of the drill chuck, with the green indicator indicating movement in a clockwise direction and the red indicator indicating movement in a counterclockwise direction.

The indicator lights may be located on the top of the driver portion of the drill housing. The red and green indicator lights and the charge test switch may be located adjacent the left side of the drill in the case of a drill primarily intended for a right-handed user.

A first workpiece illuminating light may be provided on the left-hand side of the drill, and a second workpiece illuminating light may be positioned on the top of the driver portion of the drill. A light may be positioned to principally illuminate those areas of the workpiece which are likely to be visible to the user of the tool and may comprise a plurality of light sources positioned circumferentially about a forward end of the driver portion. A workpiece illumination light may be positioned on the top of driver portion of the drill to illuminate more visible portions of the workpiece. Another workpiece illumination light may be positioned adjacent the bottom of driver portion of the drill housing to illuminate remaining more visible portions of the workpiece not likely to be covered by the hand of the user and the handle portion of the drill housing.

### BRIEF DESCRIPTION THE DRAWINGS

The operation of the invention will become apparent from the following description taken in conjunction with the drawings, in which:

FIG. 1 is a side view illustrating a drill of the type appropriate for implementation of the present invention;

FIG. 2 is a front view of the drill illustrated in FIG. 1;

FIG. 3 is a left side view of a drill advantageous for a right-handed user constructed in accordance with the present invention;

FIG. 4 is a front view of an alternative lighting arrangement;

FIG. 5 is a front view illustrating a particularly advantageous lighting arrangement in a drill incorporating the present invention;

FIG. 6 is a front view illustrating an alternative lighting arrangement;

FIG. 7 illustrates in top plan view directional indicators in accordance with an alternative embodiment of the invention;

FIG. 8 is plan view illustrating the state or charge and directional indicator of yet another alternative embodiment;

FIG. 9 is a detail of the indicator of FIG. 8;

FIG. 10 is a perspective view of the housing for the rechargeable battery during orientation of the prongs for recharging;

FIG. 11 is a perspective view of the rechargeable battery housing illustrating its configuration as a flashlight;

FIG. 12 is a side view of the inventive tool with the battery housing removed; and

FIG. 13 is a perspective view of the battery housing with the prongs in the recharging position.

### DETAILED DESCRIPTION OF THE PREFERRED EMBODIMENTS

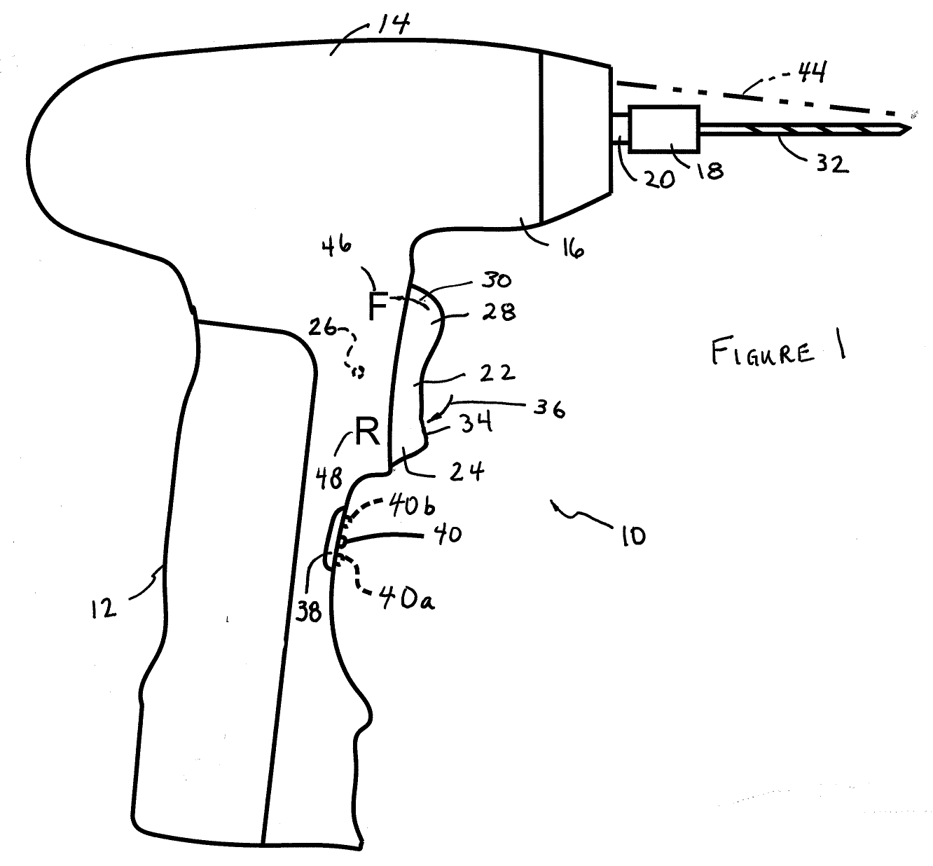

As illustrated in FIG. 1, an electric drill 10 incorporating a particularly advantageous and efficient battery testing configuration, and constructed in accordance with the present invention, is illustrated. Drill 10 includes a handle portion 12 and a driver portion 14. Driver portion 14 comprises a neck 16.

A chuck 18, of conventional design, is mounted on a spindle 20. In accordance with the preferred embodiment, it is contemplated that chuck 18 may be any conventional hex socket chuck, as a wide variety of tool bits having mountings suitable for such chucks are readily available on the market.

Other chuck configurations, for example, a multi-fingered chuck, for example one of the type using a serrated sleeve may be employed. Alternatively, a multi-fingered chuck employing a conical gear pin key (such as that sold by Jacobs Manufacturing) may also be advantageously employed in accordance with the present invention.

Spindle 20 is coupled to a motor, not illustrated, but of conventional design, housed within driver portion 14. In accordance with the invention, drill 10 is capable of both forward and reverse movement. The same is achieved using conventional circuitry. Driving direction is selected by an on/off switch 22. Switch 22 includes a lever operator 24 mounted for rotation about a pivot bar 26, illustrated in hidden lines in FIG. 1.

Lever operator 24 is mounted with a conventional spring mechanism which biases lever operator 24 in the position illustrated in FIG. 1. Upon the application of pressure to the upper portion 28 of lever operator 24, in the direction of arrow 30, spindle 20 is caused rotate in the clockwise direction, thus causing drill bit 32 to rotate clockwise and drill into a workpiece, for example creating a hole or driving a screw into a workpiece.

It is noted that a drill bit 32 is shown for purposes of illustration, but that drill 10 may be used to rotate a wide variety of tools, such as bits with conventional slot and Philips screwdriver tips of all types and sizes, hex wrench bits and specialized tools such as star drivers and four sided drivers.

Upon the application of pressure to the lower portion 34 of lever operator 24, in the direction of arrow 36, spindle 20 is caused rotate in the counter-clockwise direction, thus causing drill 32 to rotate counter-clockwise and be withdrawn from the workpiece, leaving behind the hole.

In accordance with a preferred embodiment of the invention, a three position switch 38 with a slider selection member 40 changes the state of inventive drill 10 from a first position illustrated in dashed lines, where it is operable and lights illuminate the workpiece, to, when slider member 40 is in the position illustrated at 40a, an “on” position where the drill will operate but no illumination is provided, when slider member 40 is illustrated in solid lines. Slider member 40 may also be put in the locked position shown in dashed lines as indicated by reference numeral 40b, in which position neither tool operation nor illumination is provided. Such locking and turning on of lights using a slider switch is conventional and three position switch 38 may be of any conventional design. Light 44 is oriented in a direction which causes it to illuminate the workpiece as illustrated in FIG. 1.

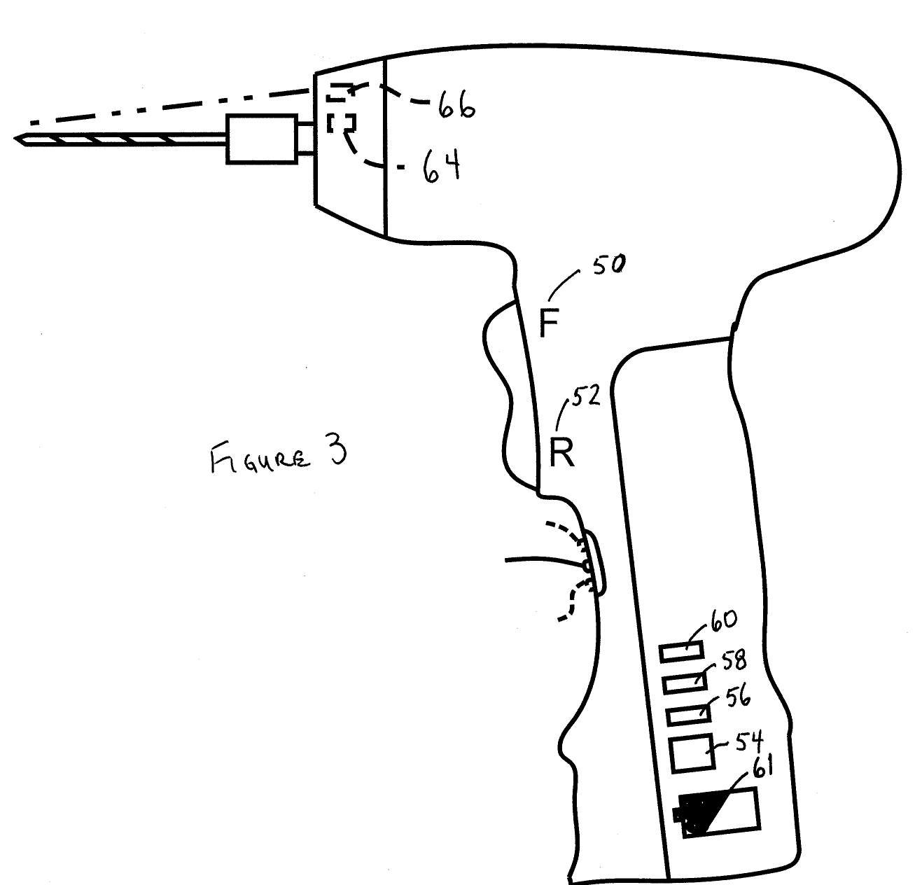

In accordance with a preferred embodiment, a marking showing the position for the application of force by the finger of the user to achieve a forward or clockwise drilling operation takes the form indicated by forward alphanumeric indicator 46. Likewise, rearward or counterclockwise motion may be achieved by squeezing switch 22 in the direction indicated by arrow 36 adjacent rearward alphanumeric indicator 48. For ease of operation a second forward alphanumeric indicator 50 and a second rearward alphanumeric indicator 52 are provided on the opposite side of the drill as illustrated in FIG. 3.

The inventive drill 10 further comprises a battery testing switch 54. Adjacent battery testing switch 54 is a red light 56 which is positioned beside a yellow light 58, which in turn, is positioned beside a green light 60. Lights 56-60 are connected to a battery testing circuit, with actuation of a red light indicating a very weak battery, and a weak battery indicated by simultaneous lighting of red light 56 and yellow light 58. Actuation of only yellow light 58 indicates a weakening battery. Actuation of yellow light 58 and green light 60 indicates a relatively strong battery condition. Finally, actuation of green light 60 indicates a battery which is substantially fully charged. These various actuation combinations may be obtained from a conventional voltage measuring circuit and a suitable gating arrangement driving the lights as are within the design capability of one of ordinary skill in the art. The presence of state of charge indication circuitry is indicated by an indicia 61 of conventional configuration.

The position of switch 54 is particularly advantageous, being on the left side of the drill handle 12 because a right-handed user is relatively unlikely to accidentally actuate switch 54. The result is a very accessible state of charge indicator. On the other hand, because the indicator lights 56-60 are also visible when the drill is held in the right hand, access is particularly easy. Likewise, switch 54 is easily accessible to the left hand when the drill is held in the normal position by the right hand, which also promotes ease-of-use.

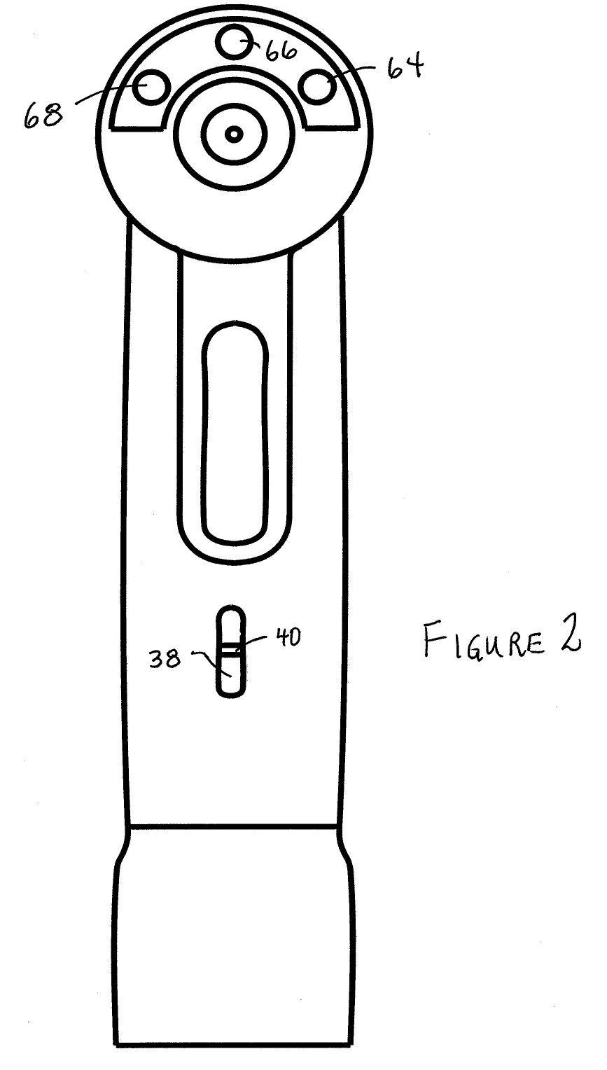

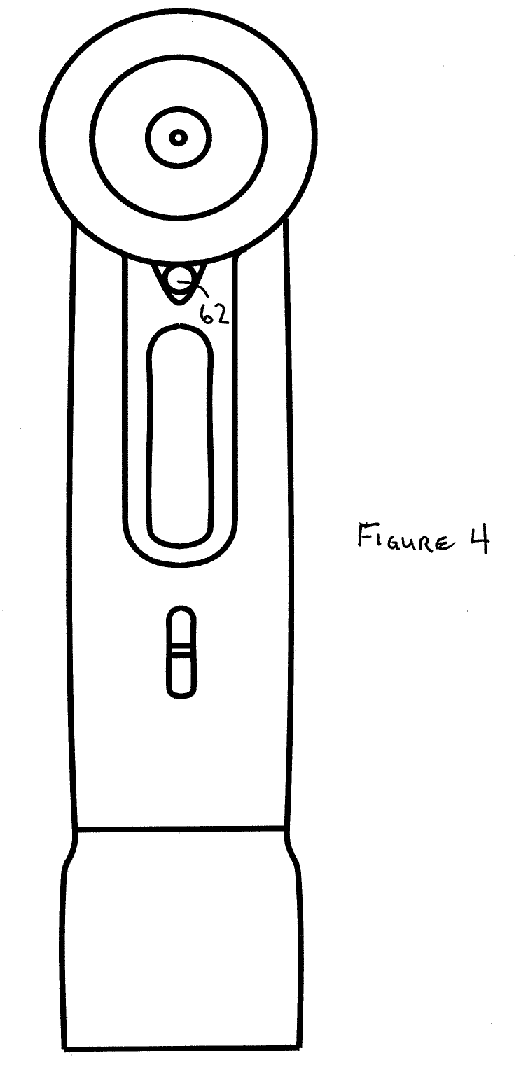

n accordance with a preferred embodiment of the invention, lights, for example light emitting diodes are provided to illuminate the workpiece. Generally, that portion of the workpiece, which lies adjacent to the handle, is not easily visible or commonly visible to the user. Accordingly, the provision of lights in such a position, for example as illustrated by light 62 in FIG. 4 may not be the most advantageous arrangement, because it illuminates portions of the workpiece which are not visible. Accordingly, in accordance with the invention, as illustrated in FIGS. 2 and 3, lights 64, 66 and 68 are provided in positions which are more efficient.

More particularly, light 64 on the left-hand side of the drill illuminates the most visible portions of the workpiece. Likewise, light 66 positioned on the top of driver portion 14 of drill 10 illuminates relatively visible portions of the workpiece. Finally, light 68 illuminates the remaining portion of the workpiece not likely to be covered by the hand of the user and handle portion 12 of drill 10.

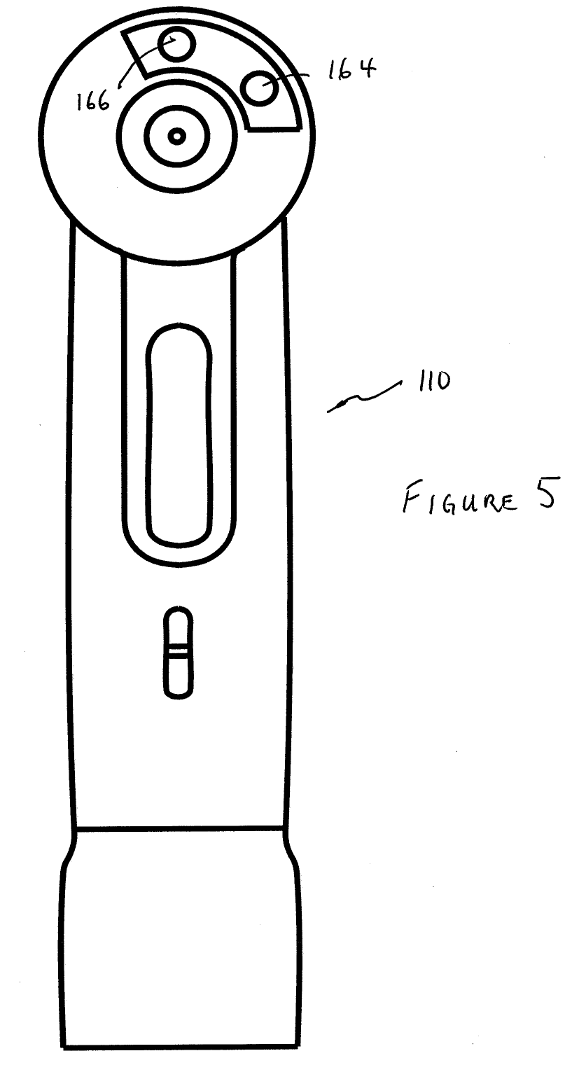

An alternative embodiment of the inventive drill 110 is illustrated in FIG. 5. Drill 110 is similar to drill 10 except for the inclusion of a light illumination package comprising lights 164 and 166. This arrangement takes care of the two most effective lighting areas being at the top and the left-hand side of the drill in the case of a right-handed user. This configuration may be reversed for left-handed users with the reconfiguration of light 164 to a position on the right side of the drill (as opposed to the left side of the drill).

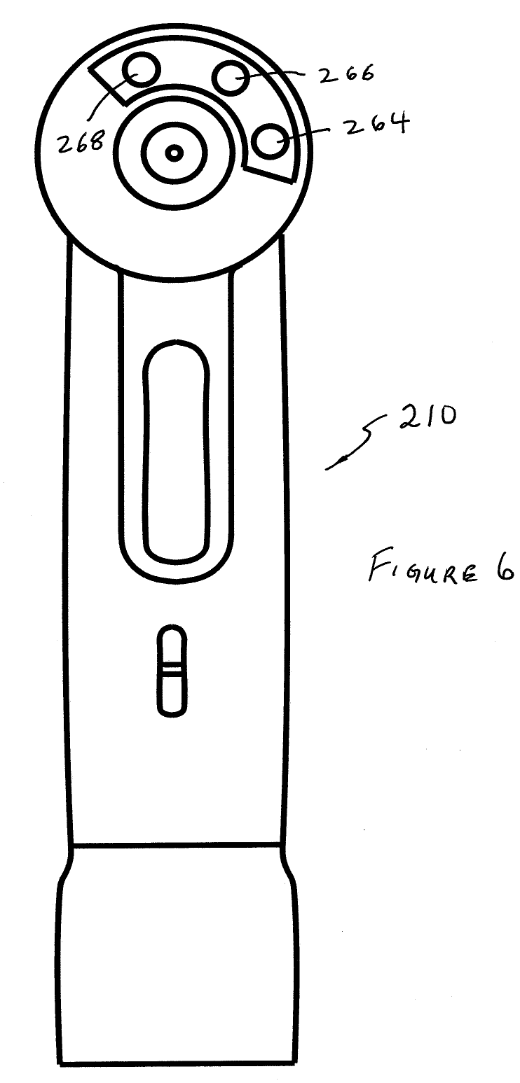

In accordance with the invention, as illustrated in FIG. 6, it is contemplated that a drill 210 may comprise three lights 264, 266 and 268. This results in added illumination, as well as some additional lighting on the right side of the drill.

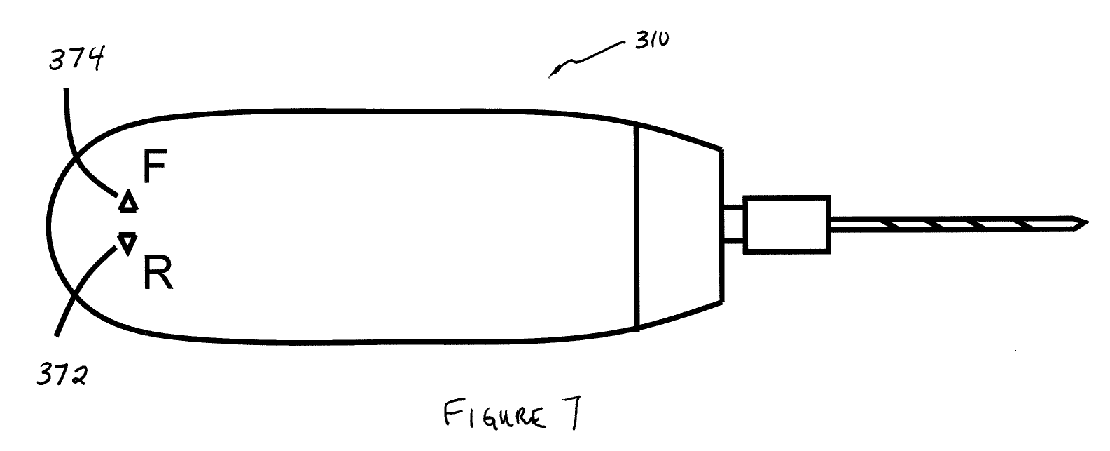

As illustrated in FIG. 7, the inventive drill 310 may be provided with a direction of movement indicator light 372 which is actuated when the drill is moving in the clockwise or forward direction. Light 372 is in accordance with the preferred embodiment of the present invention green in color. Light 72 is associated with an alphanumeric indicator 73. Similarly, light 74 indicates movement in the reverse or counterclockwise direction, and is illuminated when the drill is moving in that direction. Light 374 is red in color. Both lights 72 and 74 and indicators 73 and 75 are visible from behind drill 10, as illustrated in FIG. 5.

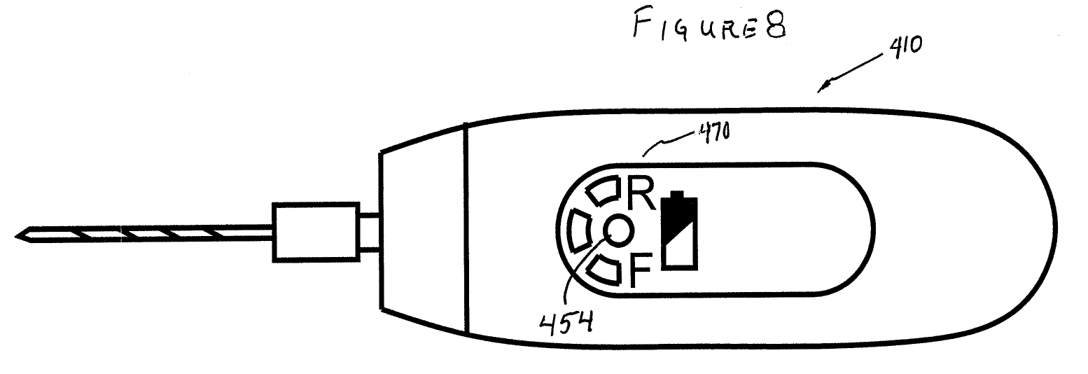

As an alternative to the state of charge indicator illustrated in the embodiment of FIGS. 1-3, the inventive drill may have an indicator arrangement as illustrated in FIG. 8. In accordance with this embodiment, the inventive drill includes an indicator 470 located on the top of the drill 410.

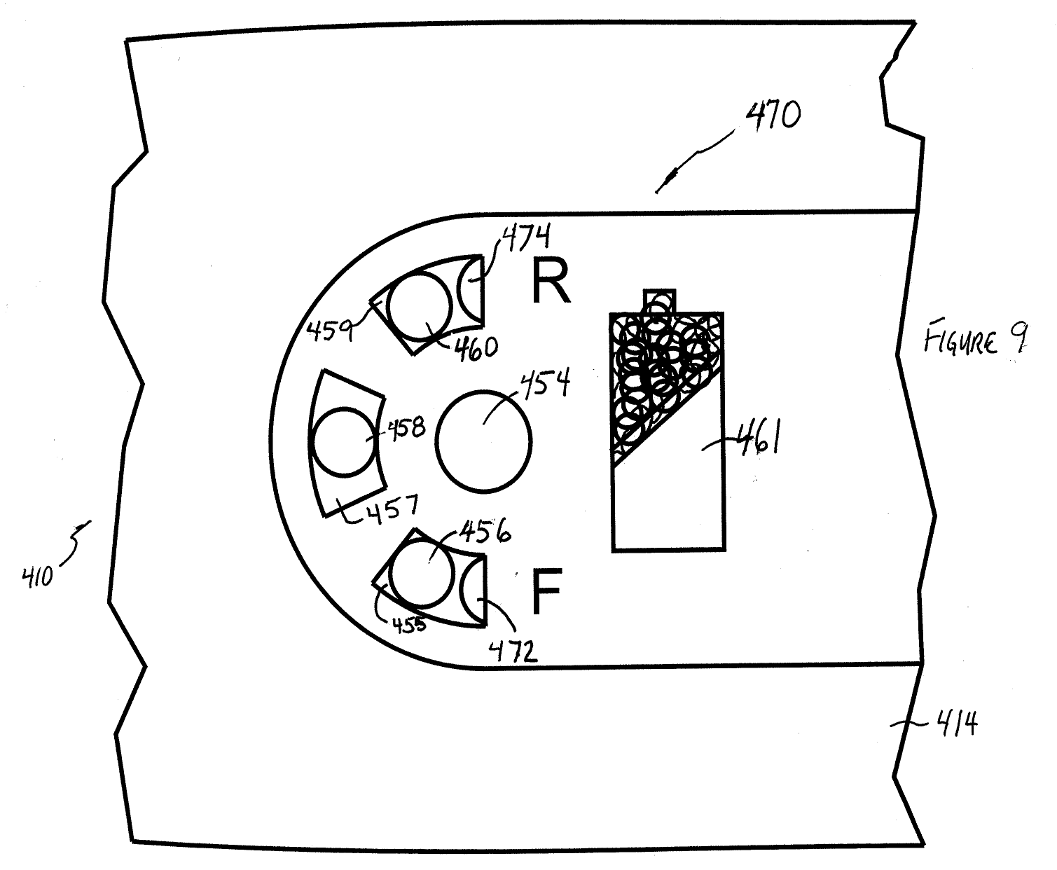

Referring to FIGS. 8 and 9, inventive drill 410 further comprises a battery testing switch 454 located on the top of the housing. Adjacent battery testing switch 454 is a window 455 behind which is mounted a red light 456. In accordance with the present invention, window 455 is made of a transparent plastic which allows light from light 456 to exit. In accordance with the preferred embodiment, light 456 as well as the other lights included in the various embodiments of the invention are light emitting diodes, although of the light sources, principle, may be used. Window 455 and light 456 are positioned circumferentially beside the second window 457, behind which is positioned a yellow light 458. A third window 459 is positioned circumferentially beside window 457. A green light 460 is positioned behind window 459

Lights 456-460 are connected to a battery testing circuit, with actuation of a red light indicating a very weak battery, and a weak battery indicated by simultaneous lighting of the red light 456 and yellow light 458. Actuation of only yellow light 458 indicates a weakening battery. Actuation of yellow light 458 and green light 460, simultaneously, indicates a relatively strong battery condition. Finally, actuation of green light 460 indicates a battery which is substantially fully charged. These various actuation combinations may be obtained from a conventional voltage measuring circuit and a suitable gating arrangement driving the lights. The presence of state of charge indication circuitry is indicated by an indicia 461 of conventional configuration.

The position of switch 454 is particularly advantageous, being on the top of the drill driver portion 414 because it is not likely to be accidentally actuated. The result is a very accessible state of charge indicator. On the other hand, because the indicator lights 456-460 are also visible when the drill is held in either hand, access is particularly easy. This promotes ease-of-use.

Indicator 470 also includes green indicator lights 472 which is actuated when the inventive drill 410 is turned on in the forward or clockwise direction. Similarly, red lights 474 is actuated when drill 410 is turned on in the reverse or counterclockwise direction.

In accordance with a preferred embodiment of the invention, indicator lights 472 and 456 are different colors, in order to avoid potential misinterpretation of the signal associated with light actuation. Likewise, indicator lights 474 and 460 are different colors, also in order to avoid potential misinterpretation of the signal associated with light actuation.

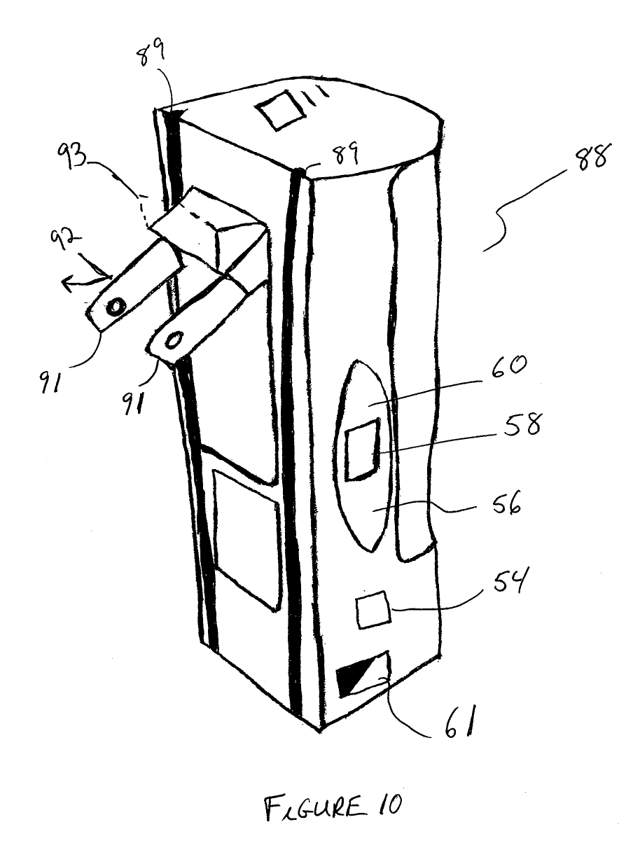

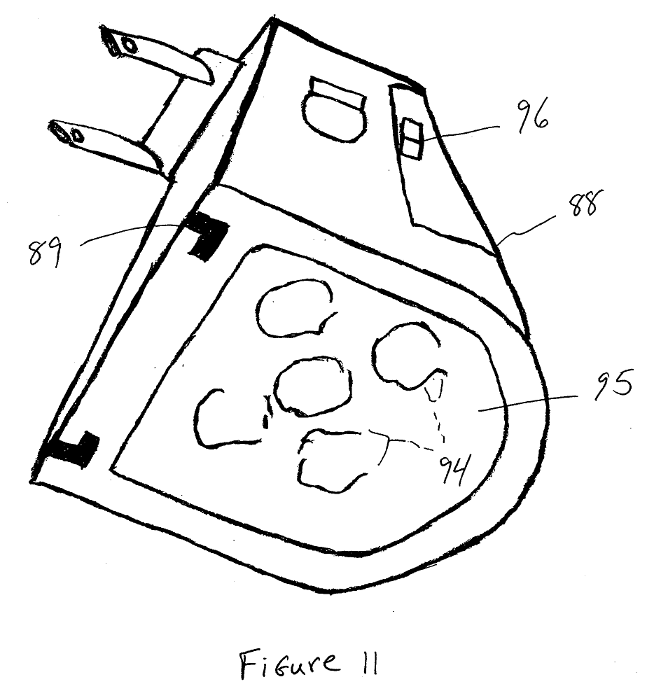

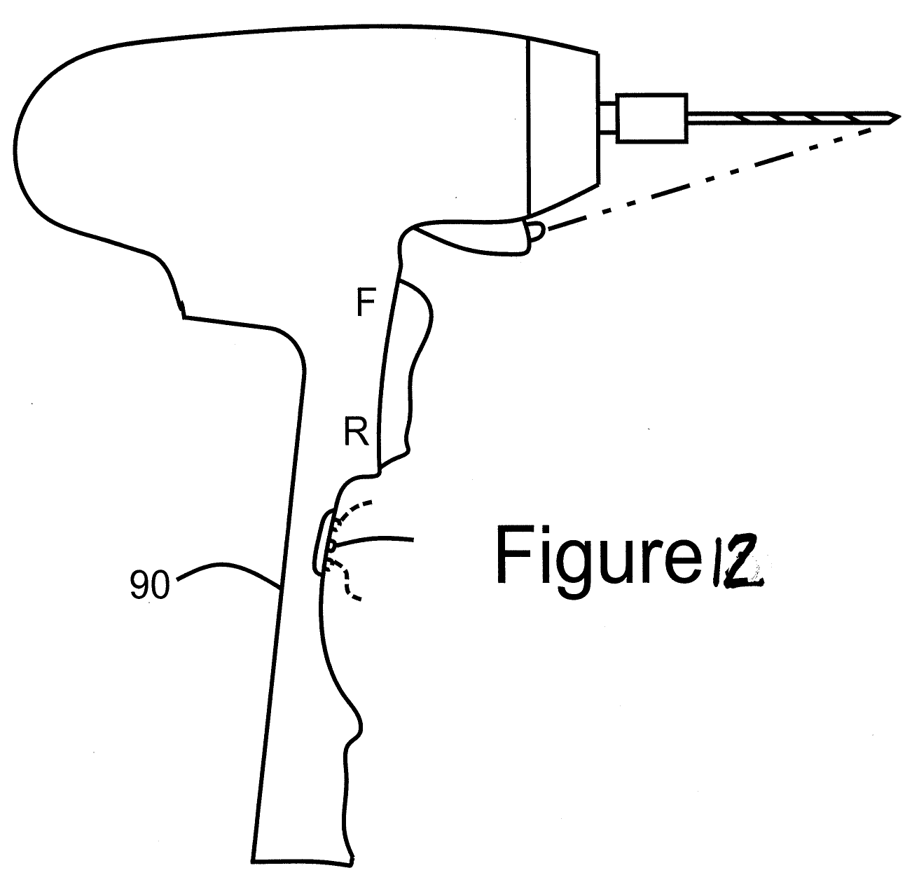

As illustrated in FIGS. 10 and 11, the battery powered drill 10 of FIG. 1 may take the form of a battery pack 88, which incorporates L-channels 89, which mate with tracks 90 (FIG. 12) on handle portion 12.

When it is desired to recharge battery pack 88, the battery pack is removed from the tool by being slid downwardly. Optionally, a lock may be provided to lock it in position, in which case the lock would have to be unlatched before the battery pack may be slid downwardly to disengage it from the drill. After battery pack 88 has been removed, rotatingly mounted male electrical current prongs 91 are rotated in the direction of arrow 92 from a stowed position to an intermediate position illustrated in FIG. 10 and finally to a charging position illustrated in dashed lines in FIG. 10 with pronged base 93 extending vertically from battery pack 88.

Prongs 91 may then be inserted into an ordinary house current socket and the battery charged. Initially, if a battery is uncharged, red light 56 is lit. When half charge is achieved, yellow light 58 only is illuminated. Finally, when full charge is achieved, only green light 60 is illuminated. Battery pack 88 may then be replaced into drill 10 and continue to power operation of drill 10.

As illustrated in FIG. 11, battery pack 88 also incorporates one or, as illustrated, a number of light emitting diodes 94 placed behind an optional lens 95. Lens 95 may be simply a clear flat plastic member made from a sheet of clear plastic material or may have a focusing or other optical function. Light emitting diodes 94 have relatively high intensity compared to the other light emitting diodes on drill 10. Light emitting diodes 94 thus act as a flashlight. Their operation may be controlled by a switch 96 which may be a simple on-off switch, or it may be a switch which selectively illuminates one, three or five of the light emitting diodes 94.

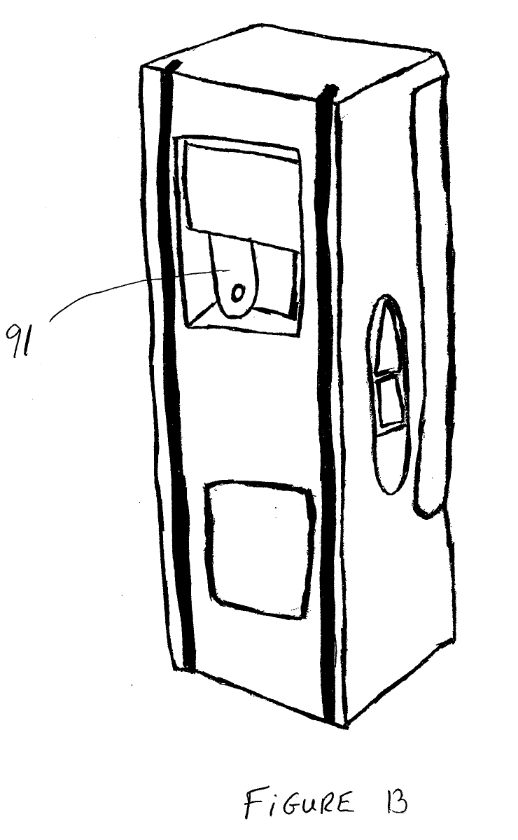

Power is coupled from battery pack 88 by a pair of electrical contacts (not illustrated) which mate with contacts on the handle portion of the tool body illustrated most clearly in FIGS. 11 and 12. FIG. 12 shows the tool with the battery removed. The battery pack 88 with prongs 91 fully in the retracted position is illustrated in FIG. 13.

While an illustrative embodiment of the invention has been described, it is, of course, understood that various modifications may be made from the illustrated embodiment of the invention without departing from the spirit and scope of the invention, which is limited and defined only by the following claims.

What is claimed:

1. A drill, comprising:
(a) a drill housing comprising a handle portion and a driver portion;
(b) an electrical drill motor located in said driver portion, said drill motor having an output shaft for coupling output rotary power;
(c) an electrical switch for controlling the operation of said drill motor, said electrical switch being located on said handle portion of said drill housing;
(d) a chuck coupled to the output shaft of said drill motor;
(e) charge state measuring circuitry having a plurality of output terminals, actuation of said output terminals or combination of output terminals each corresponding to a particular state of charge;
(f) a red indicator light coupled to one of said output terminals, said one of said output terminals indicating a relatively poor state of charge;
(g) a green indicator light coupled to one of said output terminals, said one of said output terminals indicating a relatively good state of charge; and
(h) a charge test switch for actuating said charge state measuring circuitry.

2. Apparatus as in claim 1, wherein the charge state measuring circuitry further comprises an output terminal for driving a yellow light, and said charge state measuring circuitry i) actuates said yellow light to indicate a condition which is neither good nor poor, ii) actuates said green light and said yellow light simultaneously to indicate a battery charge condition that is better than that indicated by said yellow light but not as good as that indicated by said green light and, iii) actuates said red light and said yellow light simultaneously to indicate a battery charge condition that is worse than that indicated by said yellow light but not as bad as that indicated by said red light.

3. Apparatus as in claim 1, wherein said indicator lights are located on the left side of the handle portion of said drill housing.

4. Apparatus as in claim 1, further comprising a green directional indicator and a red directional indicator, said green indicator indicating movement in a clockwise direction and said red indicator indicating movement in a counterclockwise direction.

5. A drill, comprising:
(a) a drill housing comprising a handle portion and a driver portion;
(b) an electrical drill motor located in said driver portion, said drill motor having an output shaft for coupling output rotary power;
(c) an electrical switch for controlling the operation of said drill motor, said electrical switch being located on said handle portion of said drill housing;
(d) a chuck coupled to the output shaft of said drill motor;
(e) charge state measuring circuitry having a plurality of output terminals, actuation of said output terminals or combination of output terminals each corresponding to a particular state of charge;
(f) a first charge state indicator light in a first color coupled to one of said output terminals, said one of said output terminals indicating a relatively poor state of charge;
(g) a second charge state indicator light in a second color coupled to one of said output terminals, said one of said output terminals indicating a relatively good state of charge;
(h) a third charge state indicator light in a third color coupled to one of said output terminals, said one of said output terminals indicating a state of charge better than that indicated by said second indicator light and not as good as that indicated by said first indicator light; and
(h) a charge test switch for actuating said charge state measuring circuitry, said the charge state measuring circuitry further comprising an output terminal for driving said third charge state indicator light, and said charge state measuring circuitry i) actuates said third charge state indicator light to indicate a condition which is neither good nor poor, ii) actuates said first charge state indicator light and said third charge state indicator light simultaneously to indicate a battery charge condition that is better than that indicated by said third charge state indicator light but not as good as that indicated by said first charge state indicator light and, iii) actuates said second charge state indicator light and said third charge state indicator light simultaneously to indicate a battery charge condition that is worse than that indicated by said third charge state indicator light but not as bad as that indicated by said second charge state indicator light.

6. A drill as in claim 1, wherein a first workpiece illuminating light is provided on the left-hand side of the drill, and a second workpiece illuminating light is positioned on the top of driver portion of said drill.
